(19) United States
(12) Patent Application Publication
(10) Pub. No.: US 2016/0249239 A1
(43) Pub. Date: Aug. 25, 2016

(54) METHOD AND APPARATUS FOR CORRELATION OF DATA FROM AN EXTERNAL SOURCE AND A NETWORK BASED SOURCE

(71) Applicant: AT&T Intellectual Property I, L.P., Atlanta, GA (US)

(72) Inventors: Syed Anwar Aftab, Budd Lake, NJ (US); Abbas Munawar Fazal, Bridgewater, NJ (US); Arthur W. Martella, Morris Plains, NJ (US)

(21) Appl. No.: 14/628,013

(22) Filed: Feb. 20, 2015

(51) Int. Cl. H04W 24/06; G06F 17/30

(52) U.S. Cl. CPC H04W 24/06; G06F 17/30864; H04W 84/045

(57) ABSTRACT

A method and apparatus for correlating data obtained from an external source with a particular network based record are disclosed. For example, the method implemented via a processor obtains the data from the external source, wherein the data comprises test records for a plurality of test calls, identifies one or more mobile devices associated with the test records obtained from the external source, retrieves a plurality of network based records associated with the one or more mobile devices that are identified, selects a particular test call from among the plurality of test calls, searches for a particular network based record from the plurality of network based records matching the particular test call in accordance with a criterion, and correlates the particular test call with the particular network based record, when the searching successfully identified the particular network based record matching the particular test call in accordance with the criterion.

The present disclosure generally relates to the correlation of data obtained from multiple sources. In one example, a network service provider may correlate data obtained from one or more external sources and one or more network based sources. In one example, the data that is correlated may be used to perform analysis on the network, on services provided by the network, and/or services supported by the network.

### BACKGROUND

Network based data is often difficult to ascertain as to its accuracy. For example, for a cellular network, the network based data may contain information pertaining to physical locations of callers using mobile devices. One way to determine the physical location of callers is to utilize triangulation techniques in conjunction with cell tower data. For instance, there may be various access points, e.g., Wireless Fidelity (WiFi) access points, in the vicinity of the caller. For example, there may be WiFi access points, access points for 2G, 3G or 4G networks, etc. The network may then base the determination of the location of the caller by triangulating and identifying which access point is being used for communicating with the mobile device. However, the accuracy of the location may be low. In addition, the level of inaccuracy of the location information may not be known. For example, the network service provider may believe that the location information is accurate 100% of the time, while there may be areas where the location accuracy is quite low.

### SUMMARY OF THE DISCLOSURE

In one embodiment, the present disclosure describes a method and apparatus for correlating data obtained from an external source with a particular network based record obtained from a network based source. For example, the method implemented via a processor obtains the data from the external source, wherein the data comprises test records for a plurality of test calls, identifies one or more mobile devices associated with the test records obtained from the external source, retrieves a plurality of network based records associated with the one or more mobile devices that are identified, selects a particular test call from among the plurality of test calls, searches for a particular network based record from the plurality of network based records matching the particular test call in accordance with a criterion, and correlates the particular test call with the particular network based record, when the searching successfully identified the particular network based record matching the particular test call in accordance with the criterion.

### BRIEF DESCRIPTION OF THE DRAWINGS

The teaching of the present disclosure can be readily understood by considering the following detailed description in conjunction with the accompanying drawings, in which:

FIG. 1 illustrates an exemplary network related to the present disclosure;

FIG. 2 illustrates a flowchart of a method of the present disclosure for correlating data obtained from an external source with a particular network based record;

FIG. 3 illustrates a more detailed flowchart of a method of the present disclosure for implementing the correlating data obtained from an external source with a particular network based record; and

FIG. 4 depicts a high-level block diagram of a computer suitable for use in performing the functions described herein.

To facilitate understanding, identical reference numerals have been used, where possible, to designate identical elements that are common to the figures.

### DETAILED DESCRIPTION

As discussed above, network based data is often difficult to ascertain as to its accuracy. In order to improve the accuracy, a network service provider may then wish to augment the data obtained from network based sources with data obtained from external sources. The data obtained from network based sources may be referred to as network based record. The data obtained from external sources may be referred to as a test record. In one example, a network service provider may employ a tester who may travel around the country and make “test” calls to simulate actual calling conditions. In making these test calls, the tester may then log test records. For example, the test records may include calling conditions, e.g., Global Positioning System (GPS) location of the tester, signal strength of a wireless connection with a cell tower as sensed by the mobile device of the tester, a speed at which the tester is traveling, e.g., in a vehicle, while making the test call, and so on. The network service provider may then obtain the test records from the tester, match it with network based records, and then perform analysis to determine the accuracy of the network based data.

However, matching the test records with the network based records is not a trivial exercise. The network service provider supports a very large number of calls on a daily basis. It is estimated that there may be billions of cellular calls being made on a daily basis. In comparison, each tester may be making several hundreds of calls per day. Thus, finding and matching the records associated with the test calls (i.e., the several hundreds of calls) with the corresponding network based records from several billions of records that the network service provider has logged is not a trivial exercise. The difficulty of the correlation task reduces the usefulness of the test records. Thus, improving the correlation of the test data obtained from external sources with the data of the internal source will be beneficial to the network service provider.

The present disclosure broadly describes a method, computer-readable storage device and apparatus for correlation of data obtained from multiple sources, e.g., correlation of data obtained from one or more external sources and one or more network based sources. Although the teachings of the present disclosure are discussed below in a context of a cellular network, the teaching is not so limited. Namely, the teachings of the present disclosure can be applied for other types of data, wherein the analysis of the data may be improved by correlating data from a plurality of different external and internal sources.

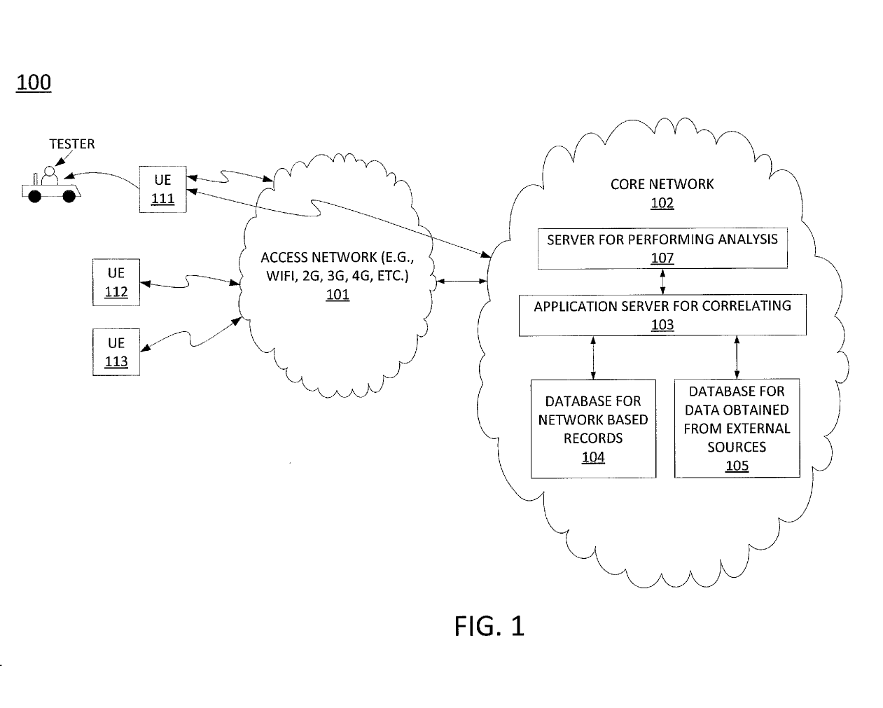

FIG. 1 illustrates an example network 100 related to the present disclosure. In one illustrative embodiment, the network 100 comprises User Endpoint (UE) devices 111-113, an access network 101, and a core network 102. Users of UE devices 111-113 may access services from the core network 102 via the access network 101.

The access network 101 may comprise a WiFi network, a cellular network (e.g., 2G, 3G, and the like), a long term evolution (LTE) network, and the like, related to the current disclosure. The core network 102 may comprise any type of communication network, such as for example, a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network. It should be noted that an IP network is broadly defined as a network that uses Internet Protocol to exchange data packets.

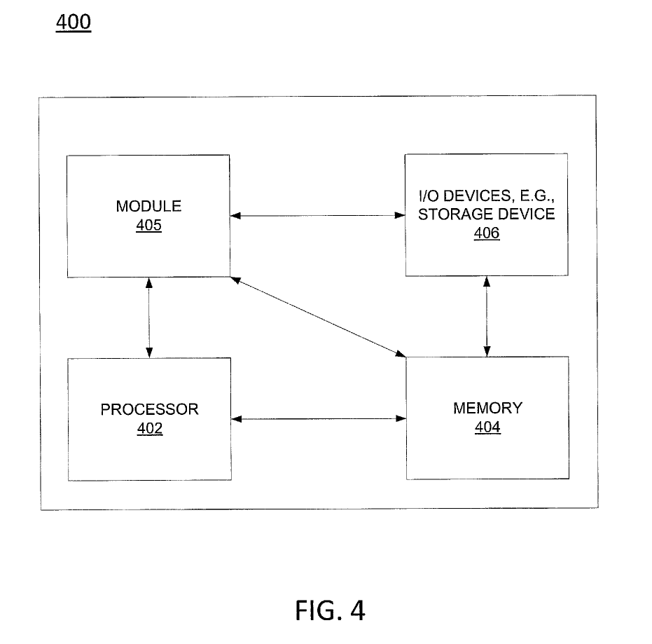

In one embodiment, the core network 102 may include an application server (AS) 103, and databases 104 and 105. The AS 103 may be deployed as a hardware device embodied as a dedicated computer (e.g., the computer 400 as illustrated in FIG. 4). In one embodiment, the AS 103 may perform the methods and functions described herein (e.g., the method 200 or method 300 discussed below).

In one embodiment, the network 100 may include additional access networks that are not shown to simplify FIG. 1. In one embodiment, the access network and the core network of FIG. 1 are simplified and it should be noted that these networks may include additional network elements (not shown), such as for example, base stations, border elements, gateways, firewalls, routers, switches, call control elements, various application servers, and the like.

In one embodiment, the database 104 is used for storing network based records, e.g., call records. For example, call records may be gathered by a Gateway Mobile Location Center (GMLC) for user endpoint devices. The GMLC may then store the network based records in the database 104.

In one embodiment, the database 105 is used for storing data obtained from external sources, e.g., test records. For example, the network service provider may have employed any number of testers who may travel around to various locations and make test calls to simulate actual calling conditions. The one or more testers may then log test records into the database 105. For example, the network service provider may specify a list of test records to be logged for each test call conducted by a tester. For example, the service provider may wish the testers to log, for each test call, a time associated with the test call, a location of the test call, e.g., Global Positioning System (GPS) location of the tester, a signal strength of a wireless connection with an access network as sensed by the UE used to originate the test call, and a speed at which the tester is traveling, e.g., a speed of a vehicle in which the tester is traveling while making the test call. Furthermore, additional fields that can be gathered from the drive test data include: the duration of the call, e.g., in seconds, information which identifies the cell tower to which the call connected (e.g., Mobile Country Code (MCC), Mobile Network Code (MNC), Location Area Code (LAC), and Service Access Code (SAC)), the number of GPS satellites in view, the digits dialed (for example, 911 when testing the E911 system), the cellular frequency used to connect (e.g., 850 MHz or 1900 MHz), and so on. The network service provider may then obtain the test records from the one or more testers and store the test records in the database 105. For example, the tester may be using UE 111. The tester may then log test records associated with test calls made via UE 111 and send the test records to the network service provider for storing in database 105.

In one embodiment, the AS 103 is used for correlating data obtained from one or more external sources with a network based data in accordance with the method of the present disclosure. For example, the AS 103 may correlate a network based record stored in database 104 with a particular test record that is stored in database 105.

In one embodiment, the core network 102 may also include a server 107 for performing an analysis. For example, the AS 103 may output the result of the correlation. The server 107 may then perform an analysis, for instance, to determine the accuracy of location data, to compare signal strength perceived experienced by UEs as compared to signal strength as shown in the network based records, and so on, via a generic analytic engine. For example, the analysis may be to uncover locations with unacceptable signal strength, physical locations with unacceptable level of location accuracy, etc. Thus, the present disclosure enables the network service provider to target improvement efforts to physical locations with the most need for improvement. However, in one embodiment, such analyses can also be performed in AS 103.

In one embodiment, the method of the present disclosure performs the correlating of the data while compensating for the data from external sources being received from multiple external sources. For example, for a particular test call, the method searches for a matching network based record from among the large amount of network based records in a database. The matching is established based on a set of criteria being met.

In one embodiment, the network service provider establishing one or more criteria for matching the particular test call with the particular network based record. In one embodiment, a criterion for matching the particular test call with the particular network based record may comprise the particular test call and the particular network based record having: a same International Mobile Subscriber Identity (IMSI) or a Mobile Directory Number (MDN), a same Mobile Country Code (MCC), a same Mobile Network Code (MNC), a same Location Area Code (LAC), a same Service Access Code (SAC), and a time of the particular test call (e.g., a time stamp of the test call) being within a predetermined time window of a time associated with the particular network based record (e.g., a time stamp of the particular network based record).

In one embodiment, the predetermined time window is determined by the network service provider. For example, the network service provider may select the time window as being the time of the network based record being between 10 seconds before the time of the particular test call and 10 seconds after the time of the particular test call.

The method then searches for all network based records meeting the criterion that is previously established. For the particular test call, the method may identify, no network based records satisfying the criterion, a single network based record satisfying the criterion, or a plurality of network based records satisfying the criterion. If no network based record satisfies the criterion, the method may keep the test call for further processing based on other criteria, as described below. For example, the method may have established another criterion with a more relaxed time window for matching. If one network based record satisfying the criterion is identified, the network based record is identified as being the matching network based record for the particular test call. If a plurality of network based records satisfies the criterion, the method may determine which particular network based record of the plurality of network based records has a time closest to the time of the particular test call. The particular network based record with the closest time to that of the particular test call is then selected as being the matching network based record for the particular test call.

Once the network based record is identified and matched with the particular test call, the network based record will not be processed for correlation with any other test calls. Thus, the method removes the network based record that has already been matched to a particular test call from among the list of network based records available for matching with another test call. The method may then proceed to processing other test calls against the remaining network based records.

In one embodiment, the method also compensates for one or more of: timing differences occurring within UEs, timing differences occurring due to a caller crossing time zone boundaries, network configuration data being unavailable, the test being performed incorrectly (e.g., failing to record time) by the tester, the test being performed using a UE with an incorrect configuration, and the like. In one embodiment, other criteria for matching may be established by relaxing one or more of the above conditions. In one example, another criterion may be established by relaxing the condition on the time window described above. For instance, a larger time window may be selected. In another example, the condition for matching a network, e.g., the MCC, the MNC, the LAC and SAC may be relaxed such that matching of three of the four conditions may suffice as to identifying a match.

In another embodiment, several criteria may be established by iteratively relaxing the matching of the one of more of the above conditions. For example, a first relaxation may be based on extending the time window to a time window greater than the one used for a first criterion. For example, the first criterion may match based on a time window associated with the network based record being within 10 seconds of the time associated with the test call. A second criterion may be established by changing the time window to be larger than the 10 seconds. For example, the second criterion may match based on a time window associated with the network based record being within 25 seconds of the time associated with the test call.

In one embodiment, the method establishes other criteria to compensate for time zone differences. For example, a third criterion may be established by changing the time window to compensate for a one hour additional difference (e.g., either a time zone of a test call being either one hour ahead or one hour behind the time zone of the network based record) due to a tester crossing a time zone boundary. If the tester crossed a time zone boundary, there may be one hour time additional time difference, as compared to the 10 seconds, described in the first criterion.

In one embodiment, the method establishes other criteria by relaxing network restriction. For example, after matching based on the first through the third criteria above are exhausted, the method may remove network restrictions for matching. In order to reduce the risk of incorrect correlation (match), the method first reduces the time window for matching to the time window of the first criterion, e.g., 10 seconds. The method may then search for matches based on first removing the restriction on service access code, followed by removing the restriction on the location area code, followed by removing the restriction on the mobile network code, and followed by removing the restriction on the mobile country code. In one embodiment, the method may remove any number of network restrictions simultaneously. For example, the method may remove restrictions on both the service access code and the location access code simultaneously. The service provider determines the network restrictions to be removed, the order in which the network restrictions are to be removed, and how many of the network restrictions may be removed.

The method continues until either all test calls are matched with a network based record, matching attempts based on all criteria are exhausted, or a condition is met for stopping any further matching attempts. For example, the service provider may have established one or more criteria for stopping the correlation attempts based on a number of test calls correlated, a percentage of test calls correlated, and so on. The criterion for stopping the correlation attempt may be based on a desired accuracy level. For example, the network service provider may know the quality of the matching (correlation) is unacceptable once a specific threshold is reached. The service provider may then establish the criterion for stopping the correlation based on reaching the specific threshold.

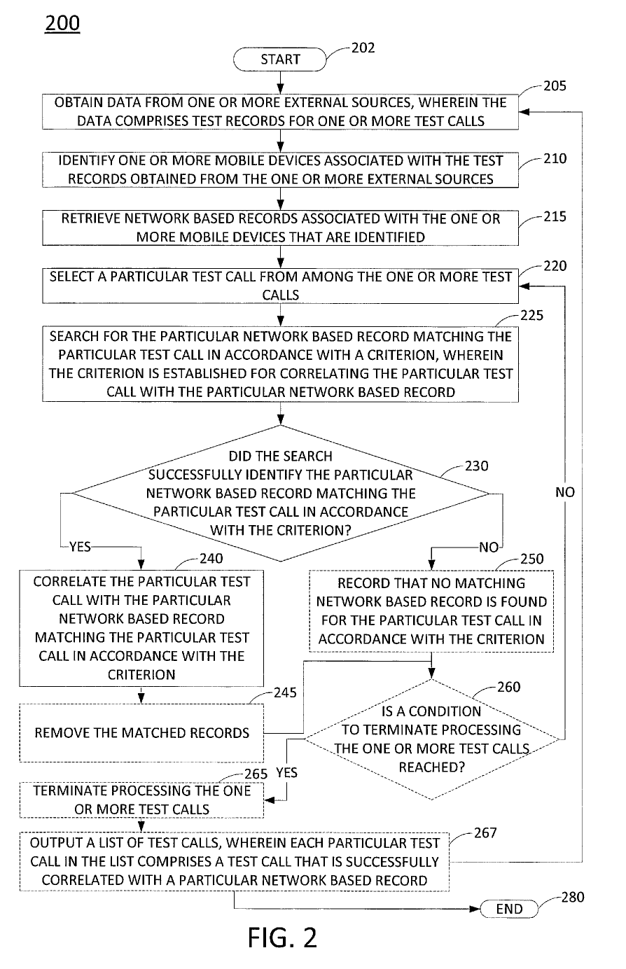

FIG. 2 illustrates a flowchart of an example method 200 of the present disclosure for correlating data obtained from an external source with a particular network based record. For example, the method may obtain from external source test records, as described above, for correlating with network based records gathered from a network based source, e.g., collected by a GMLC, as described above. In one embodiment, the method 200 may be implemented in a server, e.g., an application server 103 for performing the correlation or the computer or processor as described in FIG. 4. Method 200 starts in step 202 and proceeds to step 205.

In step 205, the processor obtains data from one or more external sources, wherein the data comprises test records for one or more test calls. For example, the processor may receive from testers test records (test data) associated with all test calls that are performed by the testers for the network service provider. For example, the test records may comprise: times of test calls, locations of test calls, signal strengths of a wireless connection with a cell tower as sensed by the mobile devices used for the test calls, speeds of test callers while traveling in a vehicle and performing the test call, and so on.

In step 210, the processor identifies one or more mobile devices associated with the test records obtained from the one or more external sources. For example, the processor may identify all mobile devices used for test calls.

In step 215, the processor retrieves network based records associated with the one or more mobile devices that are identified. For example, the method may retrieve all call records gathered by a GMLC for all of the one or more mobile devices.

In step 220, the processor selects a particular test call from among the one or more test calls. For example, the processor may select a first test call, if the processor has not processed any other test call, or a next test call, if at least one other test call has been processed.

In step 225, the processor searches for the particular network based record matching the particular test call in accordance with a criterion, wherein the criterion is established for correlating the particular test call with the particular network based record.

In step 230, the processor determines whether the search successfully identified the particular network based record matching the particular test call in accordance with the criterion. If the network based record is identified, the method proceeds to step 240. Otherwise, the method proceeds to step 250.

In step 240, the processor correlates the particular test call with the particular network based record matching the particular test call in accordance with the criterion.

In optional step 245, the processor removes the particular network based record from the network based records including removing the particular test call from the one or more test calls. In other words, the processor will remove the set of matched records (i.e., the network based record and the particular test call). For example, the particular network based record is removed such that the record would not be correlated to any other test calls that are subsequently processed. The method then proceeds to step 260.

In optional step 250, the processor records that no matching network based record is found for the particular test call in accordance with the criterion. The method then proceeds to step 260.

For example, if the match is not found in accordance with the criterion, another criterion may be used to reprocess the particular test call, after all test calls are processed using the current criterion. For example, the other criterion may be derived by performing one of more of: relaxing time period requirements, compensating for time zone changes, relaxing network restrictions, etc. Thus, the processor records the fact that no match is found using the current criterion and retains the particular test call in a list of test calls to be reprocessed via other criteria until, either the correlation attempts are performed based on each criterion that is established by the service provider or the threshold for terminating the processing is reached.

In optional step 260, the processor determines whether a condition to terminate processing the one or more test calls is reached. For example, there may be no other test calls to correlate or a threshold that may have been defined for terminating the processing of the test calls is reached. For instance, when a number of test calls or a percentage of test calls reaches a predetermined level, the network service provider may wish to terminate the process. If the condition to terminate is reached, the method proceeds to step 265. Otherwise, the method proceeds to step 220.

In optional step 265, the processor terminates processing the one or more test calls when the condition to terminate the processing the one or more test calls is reached.

In optional step 267, the processor outputs a list of test calls, wherein each particular test call in the list comprises a test call that is successfully correlated with a particular network based record. For example, the list may comprise a list of n test calls. For each of the n particular test calls, the list also provides the particular network based record, i.e., the matching network based record. The method then either proceeds to step 205 to obtain more data or proceeds to step 280 to end processing the current list of test calls.

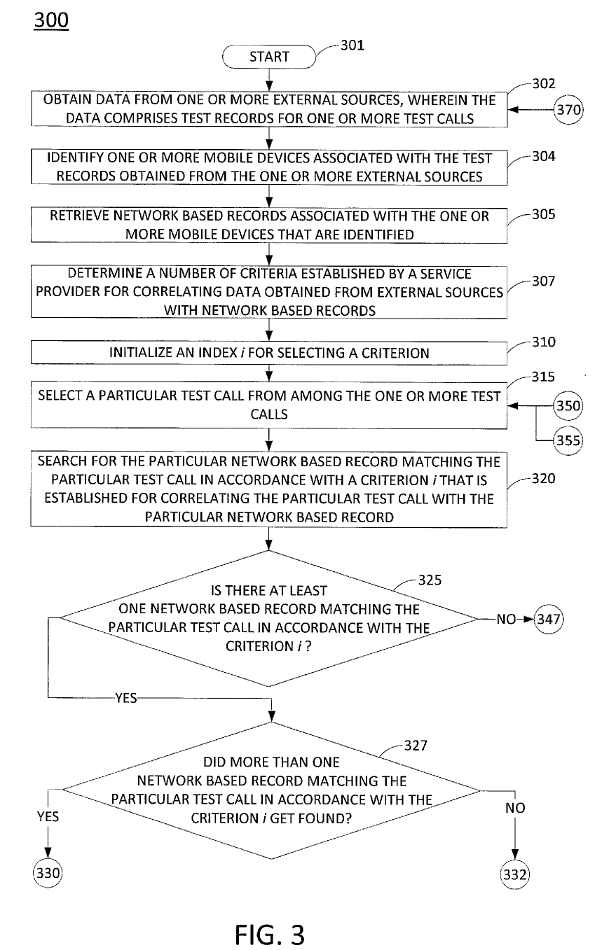

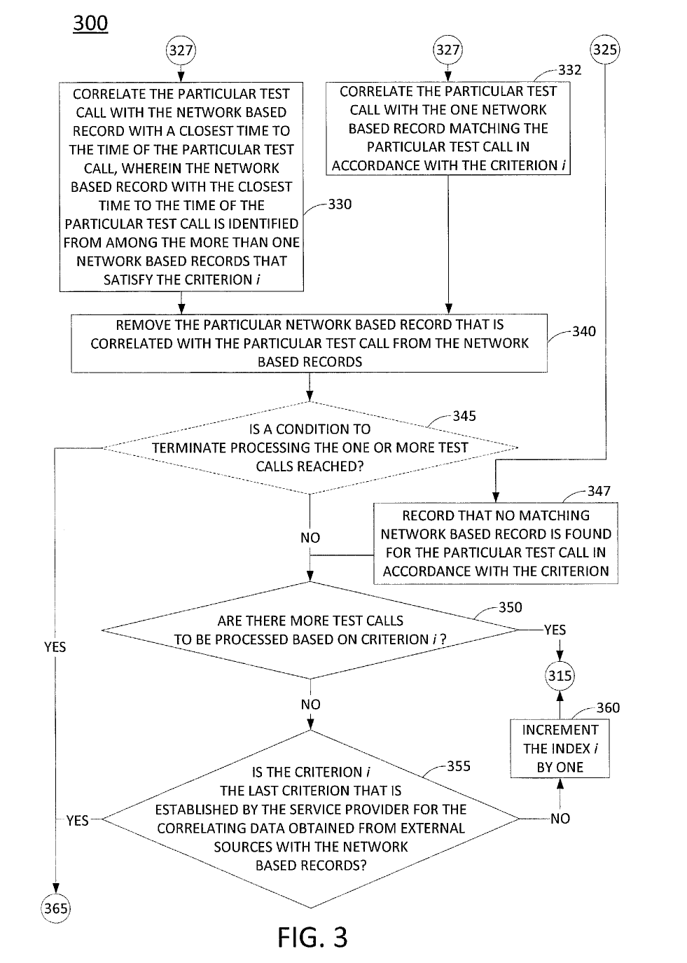

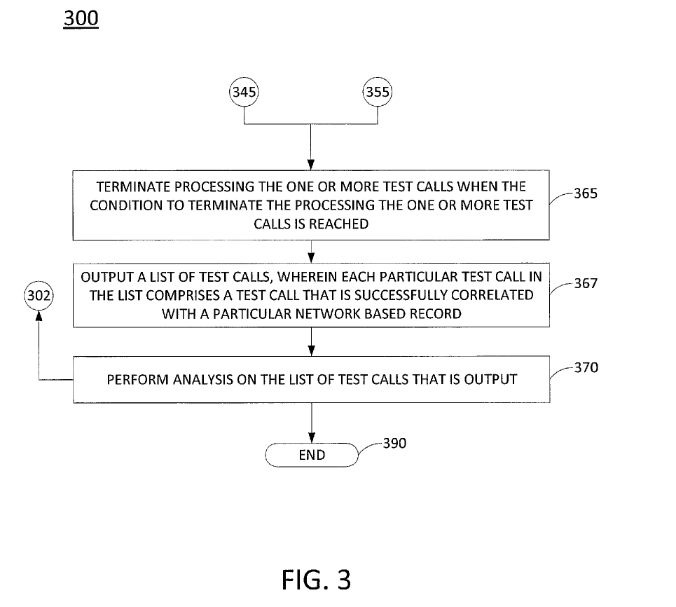

FIG. 3 illustrates a more detailed flowchart of an example method 300 of the present disclosure for implementing the correlating data obtained from an external source with a particular network based record. In one embodiment, the method 300 may be implemented in a server, e.g., an application server 103 for performing the correlation or the computer or processor as described in FIG. 4. Method 300 starts in step 301 and proceeds to step 302.

In step 302, the processor obtains data from one or more external sources, wherein the data comprises test records for one or more test calls.

In step 304, the processor identifies one or more mobile devices associated with the test records obtained from the one or more external sources. For example, the processor may identify all mobile devices used for test calls.

In step 305, the processor retrieves network based records associated with the one or more mobile devices that are identified. For example, the processor may retrieve all call records gathered by a GMLC for all of the one or more mobile devices.

In step 307, the processor determines a number of criteria established by a service provider for correlating data obtained from external sources with network based records. For example, the service provider may establish n criteria, where n is greater than or equal to one, and provide a sequence for applying the criteria for the correlation. Table-1 below illustrates an example list of criteria to be used. The list is only provided as an example.

TABLE 1
Criteria for Correlation
n = 5

| | |
|---|---|
| 1^{st} criterion | Matching the particular test call with the particular network based record |
| | when the particular test call and the particular network |
| | based record have: a same International Mobile Subscriber Identity |
| | (IMSI) or a Mobile Directory Number (MDN), a same Mobile |
| | Country Code (MCC), a same Mobile Network Code (MNC), a |
| | same Location Area Code (LAC), a same Service Access Code |
| | (SAC), and a time of the particular test call being within 10 |
| | seconds of the time associated with the particular network based |
| | record |
| 2^{nd} | Matching the particular test call with the particular network based |
| criterion | record when the particular test call and the particular network |
| | based record have: a same IMSI or MDN, a same MCC, a same |
| | MNC, a same LAC, a same SAC, and a time of the particular test |
| | call being within 25 seconds of the time associated with the |
| | particular network based record |
| 3^{rd} | Matching the particular test call with the particular network based |
| criterion | record when the particular test call and the particular network |
| | based record have: a same IMSI or MDN, a same MCC, a same |
| | MNC, a same LAC, a same SAC, and a time associated with the |
| | network based record being either: a time between 60 minutes and |
| | 10 seconds before the time associated with the test call and 59 |
| | minutes and 50 seconds before the time associated with the test |
| | call, or a time between 59 minutes and 50 seconds after the time |
| | associated with the test call and 60 minutes and 10 seconds after |
| | the time associated with the test call |
| 4^{th} | Matching the particular test call with the particular network based |
| criterion | record when the particular test call and the particular network |
| | based record have: a same IMSI or MDN, a same MCC, a same |
| | MNC, a same LAC, a same SAC, and a time associated with the |
| | network based record being either: a time between 60 minutes and |
| | 25 seconds before the time associated with the test call and 59 |
| | minutes and 35 seconds before the time associated with the test |
| | call, or a time between 59 minutes and 35 seconds after the time |
| | associated with the test call and 60 minutes and 25 seconds after |
| | the time associated with the test call |
| 5^{th} | Matching the particular test call with the particular network based |
| criterion | record when the particular test call and the particular network |
| | based record have: a same IMSI or MDN, a same MCC, a same |
| | MNC, a same LAC, and a time of the particular test call being |
| | within 10 seconds of the time associated with the particular |
| | network based record (SAC restriction removed). |

If the criteria above are not enough for reaching a desired number of correlated test calls, other criteria may be defined by removing LAC, MNC and MCC restrictions. In addition, the time restrictions may be further relaxed and so on.

In step 310, the processor initializes an index i for selecting a criterion from among the criteria, e.g., as shown in Table 1. For example, the processor initializes by setting the index i to one. The first criterion is used when the value of the index i is equal to one. The second criterion is used when the value of the index i is equal to two, and so on.

In step 315, the processor selects a particular test call from among the one or more test calls. For example, the processor may select a first test call, if the processor has not processed any other test call, or a next test call, if at least one other test call has been processed.

In step 320, the processor searches for the particular network based record matching the particular test call in accordance with a criterion i.

In step 325, the processor determines whether there is at least one network based record matching the particular test call in accordance with the criterion i. If there is at least one network based record matching the particular test call, the method proceeds to step 327. Otherwise, the method proceeds to step 347.

In step 327, the processor determines whether more than one network based record matching the particular test call in accordance with the criterion i is found. If more than one network based record satisfies the criterion i, the method proceeds to step 330. Otherwise, the method proceeds to step 332.

In step 330, the processor correlates the particular test call with the network based record with a closest time to the time of the particular test call, wherein the network based record with the closest time to the time of the particular test call is identified from among the more than one network based records that satisfy the criterion i. The method then proceeds to step 340.

In step 332, the processor correlates the particular test call with the one network based record matching the particular test call in accordance with the criterion i. The method then proceeds to step 340.

In step 340, the processor removes the particular network based record that is correlated with the particular test call from the network based records. In other words, the processor will remove the set of matched records (i.e., the network based record and the particular test call). For example, the particular network based record is removed such that the record would not be correlated to any other test calls that are subsequently processed. The method then proceeds to step 345.

In optional step 345, the processor determines whether a condition to terminate processing the one or more test calls is reached. For example, a threshold may have been defined for terminating the processing of the test calls when a number of test calls or a percentage of test calls reaches a predetermined level. If the condition to terminate is reached, the method proceeds to step 365. Otherwise, the method proceeds to step 350.

In step 347, the processor records that no matching network based record is found for the particular test call in accordance with the criterion. The method then proceeds to step 350.

In step 350, the processor determines whether there are more test calls to be processed based on criterion i. If there are more test calls to be processed based on the criterion i, the method proceeds to step 315. Otherwise, the method proceeds to step 355.

In step 355, the processor determines whether the criterion i is the last criterion that is established by the service provider for the correlating data obtained from external sources with the network based records. For example, the processor determines if the value of i is equal to n. If the criterion i is the last, the method proceeds to step 365. Otherwise, the method proceeds to step 360.

In step 360, the processor increments the index i by one. For example, the processor determines a new value for i by adding one to the previous value of i. The method then proceeds to step 315.

In optional step 365, the processor terminates processing of the one or more test calls when the condition to terminate the processing of the one or more test calls is reached.

In optional step 367, the processor outputs a list of test calls, wherein each particular test call in the list comprises a test call that is successfully correlated with a particular network based record.

In optional step 370, the processor performs analysis on the list of test calls that is output. For example, the processor may determine whether a network improvement is needed for a particular location. The method either proceeds to step 302 to obtain more data, or to step 390 to end matching the test calls with the network based records.

As such, the present disclosure provides at least one advancement in the technical field of correlating data from multiple sources. This advancement improves upon the searches that are performed to match network collected call records with records received from testers. Viewed in another manner, the present disclosure provides an efficient way to match records from multiple sources with an improved accuracy. The method allows for an iterative approach for relaxing matching criteria. The method also allows for one or more criteria for terminating the correlation process such that a low rate of false correlation can be achieved. In addition, the correlated data can then be used in various analyses to fine tune the network's capability of determining accurate location information of an UE, velocity of an UE, and signal strength as detected by the UE. The results of such analyses can then be further used to bring about better services to the subscribers. For example, improved accuracy of UE location information will enhance an opportunity to provide any number of location based services more accurately, e.g., providing a coupon as a user is passing a store or a restaurant. Similarly, improved accuracy of UE velocity information will enhance more accurate direction (e.g., navigation direction) that can be provided to the user as the user is driving a vehicle. Similarly, improved accuracy of UE perceived signal strength will enhance providing a more accurate display of signal strength on the user's UE display, and so on.

FIG. 4 depicts a high-level block diagram of a computer suitable for use in performing the functions described herein. As depicted in FIG. 4, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for correlating data from external sources with data from network based sources, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method 200 or method 300 as discussed above is implemented in a distributed or parallel manner for a particular illustrative example, i.e., the steps of the above method 200 or method 300, or the entire method 200 or method 300 is implemented across multiple or parallel computers, then the computer of this figure is intended to represent each of those multiple computers.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method. In one embodiment, instructions and data for the present module or process 405 for correlating data from external sources with data from network based sources (e.g., a software program comprising computer-executable instructions) can be loaded into memory 404 and executed by hardware processor element 402 to implement the steps, functions or operations as discussed above in connection with the exemplary method 200 or method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for correlating data from external sources with data from network based sources (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method for correlating data obtained from an external source, comprising:
obtaining, via a processor, the data from the external source, wherein the data comprises test records for a plurality of test calls;
identifying, via the processor, one or more mobile devices associated with the test records obtained from the external source;
retrieving, via the processor, a plurality of network based records associated with the one or more mobile devices that are identified;
selecting, via the processor, a particular test call from among the plurality of test calls;
searching, via the processor, for a particular network based record from the plurality of network based records matching the particular test call in accordance with a criterion; and
correlating, via the processor, the particular test call with the particular network based record, when the searching successfully identified the particular network based record matching the particular test call in accordance with the criterion.

2. The method of claim 1, wherein the criterion comprises the particular test call and the particular network based record having: a same international mobile subscriber identity, a same mobile country code, a same mobile network code, a same location area code, a same service access code, and a time of the particular test call being within a predetermined time window of a time associated with the particular network based record.

3. The method of claim 2, wherein the predetermined time window is determined by a network service provider.

4. The method of claim 2, wherein the predetermined time window of the time associated with the particular network based record comprises a time window between 10 seconds before the time of the particular test call and 10 seconds after the time of the particular test call.

5. The method of claim 2, wherein the predetermined time window of the time associated with the particular network based record comprises a time window between 25 seconds before the time of the particular test call and 25 seconds after the time of the particular test call.

6. The method of claim 2, wherein the predetermined time window of the time associated with the particular network based record comprises a time window between 60 minutes and 10 seconds before the time associated with the test call and 59 minutes and 50 seconds before the time associated with the test call, or between 59 minutes and 50 seconds after the time associated with the test call and 60 minutes and 10 seconds after the time associated with the test call.

7. The method of claim 2, wherein the predetermined time window of the time associated with the particular network based record comprises a time window between 60 minutes and 25 seconds before the time associated with the test call and 59 minutes and 35 seconds before the time associated with the test call, or a time between 59 minutes and 35 seconds after the time associated with the test call and 60 minutes and 25 seconds after the time associated with the test call.

8. The method of claim 1, wherein the criterion comprises the particular test call and the particular network based record having: a same international mobile subscriber identity, a same mobile country code, a same mobile network code, a same location area code, and a time of the particular test call being within a predetermined time window of a time associated with the particular network based record.

9. The method of claim 1, wherein the criterion comprises the particular test call and the particular network based record having: a same international mobile subscriber identity, a same mobile country code, a same mobile network code, and a time of the particular test call being within a predetermined time window of a time associated with the particular network based record.

10. The method of claim 1, wherein the criterion comprises the particular test call and the particular network based record having: a same international mobile subscriber identity, a same mobile country code, and a time of the particular test call being within a predetermined time window of a time associated with the particular network based record.

11. The method of claim 1, wherein the criterion comprises the particular test call and the particular network based record having: a same international mobile subscriber identity, and a time of the particular test call being within a predetermined time window of a time associated with the particular network based record.

12. The method of claim 1, wherein the criterion comprises the particular test call and the particular network based record having: a same mobile directory number, a same mobile country code, a same mobile network code, a same location area code, a same service access code, and a time of the particular test call being within a predetermined time window of a time associated with the particular network based record.

13. The method of claim 1, further comprising:
removing, via the processor, the particular network based record from the plurality of network based records.

14. The method of claim 1, further comprising:
recording, via the processor, that no matching network based record is found for the particular test call in accordance with the criterion, when the searching failed to identify the particular network based record matching the particular test call in accordance with the criterion.

15. The method of claim 1, further comprising:
determining, via the processor, that a condition to terminate processing of the plurality of test calls is reached; and
terminating, via the processor, the processing of the plurality of test calls.

16. The method of claim 15, further comprising:
outputting, via the processor, a list of test calls, wherein each test call in the list of test calls comprises a test call that is successfully correlated with a corresponding network based record of the plurality of network based records.

17. A non-transitory computer-readable storage device storing a plurality of instructions which, when executed by a processor, cause the processor to perform operations for correlating data obtained from an external source, the operations comprising:
obtaining the data from the external source, wherein the data comprises test records for a plurality of test calls;
identifying one or more mobile devices associated with the test records obtained from the external source;
retrieving a plurality of network based records associated with the one or more mobile devices that are identified;
selecting a particular test call from among the plurality of test calls;
searching for a particular network based record from the plurality of network based records matching the particular test call in accordance with a criterion; and
correlating the particular test call with the particular network based record, when the searching successfully identified the particular network based record matching the particular test call in accordance with the criterion.

18. The non-transitory computer-readable storage device of claim 17, wherein the criterion comprises the particular test call and the particular network based record having: a same international mobile subscriber identity, a same mobile country code, a same mobile network code, a same location area code, a same service access code, and a time of the particular test call being within a predetermined time window of a time associated with the particular network based record.

19. An apparatus for correlating data obtained from an external source, comprising:
a processor; and
a computer-readable storage device storing a plurality of instructions which, when executed by the processor, cause the processor to perform operations, the operations comprising:
obtaining the data from the external source, wherein the data comprises test records for a plurality of test calls;
identifying one or more mobile devices associated with the test records obtained from the external source;
retrieving a plurality of network based records associated with the one or more mobile devices that are identified;
selecting a particular test call from among the plurality of test calls;
searching for a particular network based record from the plurality of network based records matching the particular test call in accordance with a criterion; and
correlating the particular test call with the particular network based record, when the searching successfully identified the particular network based record matching the particular test call in accordance with the criterion.

20. The apparatus of claim apparatus 19, wherein the criterion comprises the particular test call and the particular network based record having: a same international mobile subscriber identity, a same mobile country code, a same mobile network code, a same location area code, a same service access code, and a time of the particular test call being within a predetermined time window of a time associated with the particular network based record.
